(19) United States
(12) Patent Application Publication
(10) Pub. No.: US 2025/0175564 A1
(43) Pub. Date: May 29, 2025

(54) DOCUMENT SCANNER WITH DYNAMIC ADJUSTING FUNCTION

(71) Applicant: AVISION INC., Hsinchu (TW)

(72) Inventor: YEN-CHENG CHEN, Hsinchu County (TW)

(21) Appl. No.: 18/904,476

(22) Filed: Oct. 2, 2024

(30) Foreign Application Priority Data
Nov. 24, 2023 (TW) 112145712

(51) Int. Cl. H04N 1/00

(52) U.S. Cl. CPC H04N 1/00779; H04N 1/00702

(57) ABSTRACT

A document scanner with a dynamic adjusting function includes a document detector, a penetrating light source, an image sensor and a controller. The document detector detects a transmission rate of a document, and outputs a transmission rate signal. The penetrating light source outputs original penetrating light, which penetrates through the document and becomes to-be-detected penetrating light. The image sensor receives the to-be-detected penetrating light and generates an image signal. The controller, electrically connected to the document detector, the penetrating light source and the image sensor, controls the penetrating light source to output a light-emitting amount of the original penetrating light according to the transmission rate signal. Thus, different light-emitting amounts of penetrating light for scanning can be provided according to documents with different transmission rates.

### CROSS-REFERENCE TO RELATED APPLICATIONS

This application claims priority of No. 112145712 filed in Taiwan R.O.C. on Nov. 24, 2023 under 35 USC 119, the entire content of which is hereby incorporated by reference.

### FIELD OF THE INVENTION

This disclosure relates to a document scanner, and more particularly to a document scanner with a dynamic adjusting function.

### DESCRIPTION OF RELATED ART

Nowadays, when a sheet-fed document scanner is performing document scanning, a document detector is needed to detect a time instant when a document passes through a specific position, and then the scanner starts to acquire an image of the document after a predetermined time has elapsed. The document detectors include a contact-type detector and a contactless detector. The contact-type detector has an arm pushed by the document to rotate and trigger a switch according to the principle of a lever. The contactless detector detects whether the document is present or not according to the principle of reflection or penetration.

On the other hand, the current document scanner performs scanning according to document edges, which are defined by user's settings or predetermined size settings, so the document edges cannot be defined very precisely. Therefore, how to utilize the document detector to detect the presence and the penetration property of the document, according to which a light-emitting amount of a penetrating light source of the document scanner is dynamically adjusted to assist in defining edges, holes or contours of the document is indeed a problem to be solved by this disclosure.

### SUMMARY OF THE INVENTION

It is therefore an objective of this disclosure to provide a document scanner with a dynamic adjusting function.

To achieve the above-identified objective, this disclosure provides a document scanner with a dynamic adjusting function. The document scanner includes a document detector, a penetrating light source, an image sensor and a controller. The document detector detects a transmission rate of a document, and outputs a transmission rate signal. The penetrating light source outputs original penetrating light, which penetrates through the document and becomes to-be-detected penetrating light. The image sensor receives the to-be-detected penetrating light and generates an image signal. The controller is electrically connected to the document detector, the penetrating light source and the image sensor. The controller controls the penetrating light source to output a light-emitting amount of the original penetrating light according to the transmission rate signal.

With the document scanner of the above-mentioned embodiment, the document detector can be utilized to detect presence or absence of the document, and detect penetration properties of the document, so that the light-emitting amount of the penetrating light source of the scanning module can be dynamically adjusted according to the detected results, and the scan result of the penetrating light image of the document can be optimized and be processed more easily. In addition, the dynamic adjustment may be performed document by document, may be continuously performed, or may be performed section by section.

In order to make the above-mentioned content of this disclosure more obvious and be easily understood, preferred embodiments will be described in detail as follows in conjunction with the accompanying drawings.

### BRIEF DESCRIPTION OF DRAWINGS

FIG. 1 is a schematic view showing a document scanner according to a preferred embodiment of this disclosure.

FIG. 2 is a flow chart showing implementation of dynamic adjustment.

FIG. 3 is a circuit diagram showing implementation of dynamic adjustment.

FIG. 4 shows an example of implementation of dynamic adjustment.

FIG. 5 is a schematic view showing a modified example of FIG. 1.

### DETAILED DESCRIPTION OF THE INVENTION

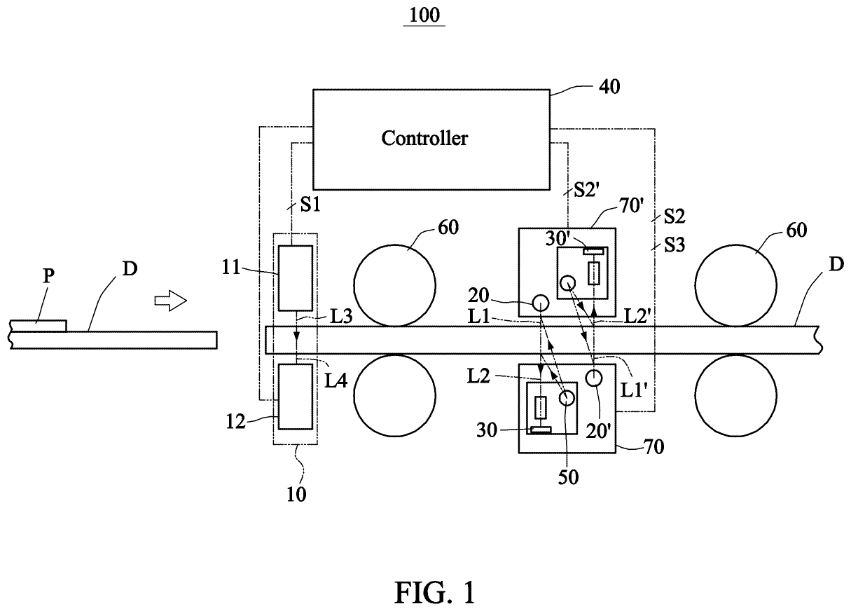

FIG. 1 is a schematic view showing a document scanner according to a preferred embodiment of this disclosure. Referring to FIG. 1, a document scanner 100 with a dynamic adjusting function includes a document detector 10, a penetrating light source 20, an image sensor 30 and a controller 40. In this embodiment, the document scanner 100 is explained by taking a sheet-fed scanner as an example, wherein transporting rollers 60 transport a document D past scanning modules 70 and 70′. Although two scanning modules are explained as an example, this disclosure is not restricted thereto because one single scanning module is also applicable.

The document detector 10 detects a transmission rate of the document D, and outputs a transmission rate signal S1. In the following example to be explained, a thickness functions as the transmission rate, and a thickness signal functions as the transmission rate signal S1, but this disclosure is not restricted thereto because a material of the document also affects the transmission rate. According to the originally presented document detector 10, the light emitting control applicable to the transmission rate detection is added, and the reference of the transmission rate is provided to achieve the function of dynamically adjusting the penetrating light source of the scanning module(s). In one example, the document detector 10 continuously detects the time instants when the document D is present and absent to provide the reference of the starting time instant for the scanning module to perform image acquiring. In another, when the document detector 10 detects presence of the document, the intermittent detection starts for a period of time, and then the continuous detection is performed so that the electric power and the data quantity can be reduced.

The penetrating light source 20 of the scanning module 70′ outputs original penetrating light L1. The original penetrating light L1 penetrates through the document D and becomes to-be-detected penetrating light L2. In one example, the original penetrating light L1 is infrared light.

The image sensor 30 of the scanning module 70 receives the to-be-detected penetrating light L2 and generates an image signal S2. The image sensor 30 is, for example, a charge-coupled device (CCD) image sensor or a contact image sensor (CIS) performing optical sensing in conjunction with a lens module (not labeled).

The controller 40 is electrically connected to the document detector 10, the penetrating light source 20 and the image sensor 30. The penetrating light source 20 is a linear light source, such as an infrared light source collocating with a light guide. The controller 40 controls, according to the transmission rate signal S1, the penetrating light source 20 to output a light-emitting amount of the original penetrating light L1, wherein the control may be made through a voltage or a current in conjunction with a light-emitting time. In one example, the light-emitting amount represents a continuous light-emitting intensity. In another example, the light-emitting amount represents an intermittent light-emitting period, such as a duty cycle of pulse width modulation, equivalent to light-emitting energy per unit time.

The document scanner 100 may further include a second penetrating light source 20′ and a second image sensor 30′. The second penetrating light source 20′ of the scanning module 70 outputs second original penetrating light L1′. The second original penetrating light L1′ penetrates through the document D and becomes second to-be-detected penetrating light L2′. The second image sensor 30′ of the scanning module 70′ receives the second to-be-detected penetrating light L2′ and generates a second image signal S2′. The controller 40 is electrically connected to the scanning modules 70 and 70′. Therefore, the controller 40 is further electrically connected to the second penetrating light source 20′ and the second image sensor 30′. Thus, the controller 40 may further control, according to the transmission rate signal S1, the second penetrating light source 20′ to output a light-emitting amount of the second original penetrating light L1′.

The document detector 10 includes a light emitter 11 and an optical receiver 12. The light emitter 11 outputs first penetrating light L3, which penetrates through the document D and becomes first to-be-detected light L4. The optical receiver 12 receives the first to-be-detected light L4 and generates the transmission rate signal S1, wherein the light emitter 11 and the optical receiver 12 are disposed on two opposite sides of the document D.

In another example, however, it is understandable that the document scanner 100 may also be a flatbed scanner, wherein a driving mechanism (not shown) drives the scanning modules 70 and 70′ and the document detector 10 to move, and the document detector 10 is disposed upstream of the scanning modules 70 and 70′ based on the moving direction of the scanning modules 70 and 70′.

In addition, the document scanner 100 may further include a visible light source 50, wherein the document D reflects the visible light, outputted from the visible light source 50, to the image sensor 30, so that the image sensor 30 further generates a visible light signal S3. The controller 40 can define the contour of the document D according to the visible light signal S3 and the image signal S2, so that the precise boundary cropping effect can be achieved.

It is understandable that a photo P may be pasted on the document D. In this case, the document D has multiple sections with different thicknesses or transmission rates. In this case, the document detector 10 can detect different thicknesses or transmission rates of the multiple sections of the document D and output the transmission rate signal S1, so that the controller 40 can control the penetrating light source 20 to output the original penetrating light L1, having different light-emitting amounts, to the document D, and the scan requirements on the sections of different thicknesses or transmission rates are satisfied.

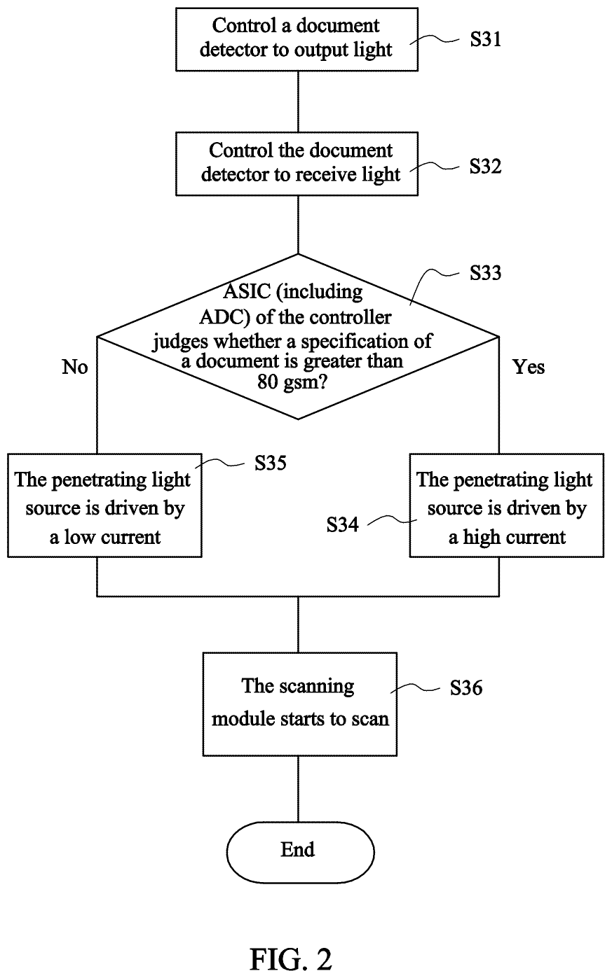

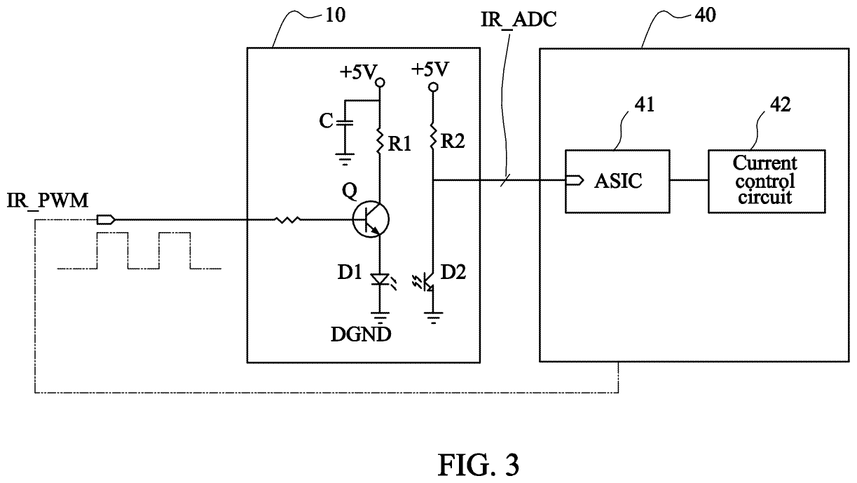

FIG. 2 is a flow chart showing implementation of dynamic adjustment. FIG. 3 is a circuit diagram showing implementation of dynamic adjustment. Referring to FIGS. 1 to 3, the controller 40 outputs a PWM signal IR_PWM in a pulse width modulation (PWM) manner and works in conjunction with a capacitor C, a resistor R1 and a transistor Q, and thus controls a photodiode D1 of the document detector 10, having one end coupled to a digital ground terminal DGND, to output the first penetrating light L3 according to the PWM signal IR_PWM in a step S31. In a step S32, the controller 40 works in conjunction with a resistor R2 to control a photodiode D2 of the document detector 10 to receive the first to-be-detected light L4 and generate an analog voltage signal IR_ADC. Then, in a step S33, an analog-to-digital converter (ADC) of an application specific integrated circuit (ASIC) 41 of the controller 40 converts the analog voltage signal into a digital signal, and the ASIC 41 converts the digital signal into the transmission rate signal S1 representative of the thickness or transmission rate of the document D, and further judges whether the transmission rate signal S1 is higher than a predetermined level. In one example, the predetermined level may correspond to the specification of the document D, and the controller 40 may judge whether the specification of the document D is greater than 80 gsm (grams per square meter), for example, according to the transmission rate signal S1 and data in the database. That is, it is judged whether the thickness of the document corresponds to the thickness of the sheet greater than 80 gsm, wherein the thickness of the sheet of 80 gsm ranges from 0.063 mm to 0.073 mm, for example.

If the transmission rate signal S1 is higher than the predetermined level, then the process enters a step S34, in which a current control circuit 42 of the controller 40 controls the penetrating light source 20 to output the original penetrating light L1 according to a first current (e.g., the high current). If the transmission rate signal S1 is not higher than the predetermined level, then the process enters a step S35, in which the current control circuit 42 of the controller 40 controls the penetrating light source 20 to output the original penetrating light L1 according to a second current (e.g., the low current), wherein the second current is lower than the first current. Next, in a step S36, the scanning module starts to perform the image acquiring operation. Such the control method provides a simple classification method, according to which an ordinary document may be scanned to obtain a good result. Thus, the controller 40 can simply process the sensing result, obtained after the image sensor 30 performs sensing using the penetrating light, into a contour result corresponding to the contour of the document D, so that the contour result can be combined with the reflected light sensing result, and the effect of boundary cropping or hole defining can be precisely achieved.

The above-mentioned example only relates to a two-stage example of controlling the penetrating light source 20, but does not restrict this disclosure thereto. In another example, the controller 40 can control, according to a level of the transmission rate signal S1, the penetrating light source 20 in a continuous current control manner to output the original penetrating light L1. The above-mentioned continuous classification method is applicable to more types of document contour detections.

It is understandable that the controller may also perform calibration according to a standard document having a known thickness, and adjust the duty cycle of the PWM signal in the step S31 according to the obtained transmission rate signal S1 to prevent the document detector 10, which gets deteriorated or dirty, from affecting the sensing results and the subsequent processing procedures.

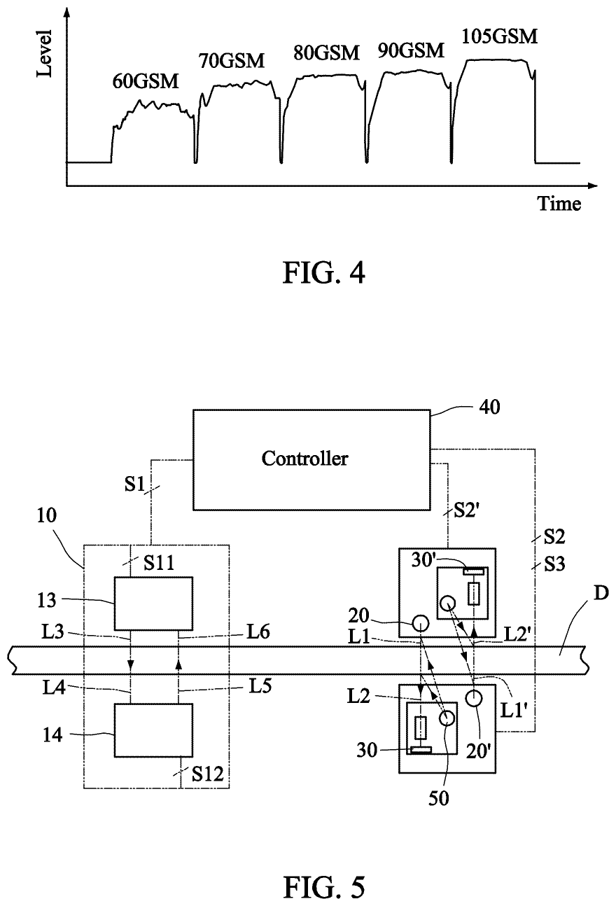

FIG. 4 shows an example of implementation of dynamic adjustment. Referring to FIG. 4, the PWM control method is performed at the conditions of the current equal to 61 mA and the duty cycle equal to 67%, wherein five sheets, which have different thicknesses and are not particularly sorted, are detected, and the analog voltage signals are transmitted to the controller. The controller samples and analyzes the analog voltage signals to distinguish the thicknesses of the sheets (corresponding to pounds), and the result of FIG. 4 can be obtained. With this structure, the ASIC can dynamically adjust the brightness of the penetrating light source for scanning the document, and the optimum result is obtained to facilitate the subsequent image processing.

FIG. 5 is a schematic view showing a modified example of FIG. 1. Referring to FIG. 5, this modified example is similar to FIG. 1 except for the difference that the document detector 10 includes a first optical transceiver 13 and a second optical transceiver 14 disposed on two opposite sides of the document D. The first optical transceiver 13 outputs first penetrating light L3. The first penetrating light L3 penetrates through the document D and becomes first to-be-detected light L4. The second optical transceiver 14 outputs second penetrating light L5. The second penetrating light L5 penetrates through the document D and becomes second to-be-detected light L6. The first optical transceiver 13 receives the second to-be-detected light L6 and generates a first sub-signal S11. The second optical transceiver 14 receives the first to-be-detected light L4 and generates a second sub-signal S12. Thus, the transmission rate signal S1 includes the first sub-signal S11 and the second sub-signal S12.

In one example, the controller 40 controls the penetrating light source 20 according to an average level represented by the first sub-signal S11 and the second sub-signal S12.

In another example, the controller 40 controls the penetrating light source 20 and another penetrating light source according to the first sub-signal S11 and the second sub-signal S12, respectively. In this case, the second penetrating light source 20′ outputs second original penetrating light L1′, and the second original penetrating light L1′ penetrates through the document D and becomes second to-be-detected penetrating light L2′. The second image sensor 30′ receives the second to-be-detected penetrating light L2′ and generates a second image signal S2′. Therefore, the controller 40 controls, according to the second sub-signal S12, the penetrating light source 20 to output the light-emitting amount of the original penetrating light L1. On the other hand, the controller 40 controls, according to the first sub-signal S11, the second penetrating light source 20′ to output the light-emitting amount of the second original penetrating light L1′. Thus, the requirement that the penetrating light presents different penetration properties in different thickness directions of the document D can be satisfied. For example, the document is smooth on one side and is rough on the other side, and two standards are adopted to scan the two sides of the document, so that the better effects can be obtained.

With the document scanner of the above-mentioned embodiment, the document detector can be utilized to detect presence or absence of the document, and detect penetration properties of the document, so that the light-emitting amount of the penetrating light source of the scanning module can be dynamically adjusted according to the detected results, and the scan result of the penetrating light image of the document can be optimized and be processed more easily. In addition, the dynamic adjustment may be performed document by document, may be continuously performed, or may be performed section by section.

It is worth noting, all the above embodiments can be combined, replaced or modified interactively as appropriate to provide diversified effects.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. A document scanner with a dynamic adjusting function, the document scanner comprising:
a document detector detecting a transmission rate of a document, and outputting a transmission rate signal;
a penetrating light source being disposed downstream of the document detector and outputting original penetrating light, wherein the original penetrating light penetrates through the document and becomes to-be-detected penetrating light;
an image sensor being disposed downstream of the document detector, receiving the to-be-detected penetrating light and generating an image signal; and
a controller electrically connected to the document detector, the penetrating light source and the image sensor, wherein the controller controls the penetrating light source to output a light-emitting amount of the original penetrating light according to the transmission rate signal, and to assist in defining an edge, a hole or a contour of the document.

2. The document scanner according to claim 1, further comprising:
a second penetrating light source outputting second original penetrating light, which penetrates through the document and becomes second to-be-detected penetrating light; and
a second image sensor receiving the second to-be-detected penetrating light and generates a second image signal, wherein the controller is further electrically connected to the second penetrating light source and the second image sensor, and further controls the second penetrating light source to output a light-emitting amount of the second original penetrating light according to the transmission rate signal.

3. The document scanner according to claim 1, wherein the document detector comprises:
a light emitter outputting a first penetrating light, which penetrates through the document and becomes first to-be-detected light; and
an optical receiver receiving the first to-be-detected light and generating the transmission rate signal, wherein the light emitter and the optical receiver are disposed on two opposite sides of the document.

4. The document scanner according to claim 3, wherein the controller controls, in a pulse width modulation manner, the document detector to output the first penetrating light, and controls the document detector to receive the first to-be-detected light and generate an analog voltage signal, and the controller converts the analog voltage signal into the transmission rate signal representative of the transmission rate of the document.

5. The document scanner according to claim 4, wherein the controller further judges whether the transmission rate signal is higher than a predetermined level; wherein if the transmission rate signal is higher than the predetermined level, then the controller controls the penetrating light source to output the original penetrating light according to a first current; and if the transmission rate signal is not higher than the predetermined level, then the controller controls the penetrating light source to output the original penetrating light according to a second current lower than the first current.

6. The document scanner according to claim 1, further comprising a visible light source, wherein the document reflects visible light, outputted from the visible light source, to the image sensor, and the image sensor further generates a visible light signal.

7. The document scanner according to claim 1, wherein the document detector comprises:
a first optical transceiver outputting a first penetrating light which penetrates through the document and becomes first to-be-detected light; and
a second optical transceiver outputting second penetrating light which penetrates through the document and becomes second to-be-detected light, wherein the first optical transceiver receives the second to-be-detected light and generates a first sub-signal, the second optical transceiver receives the first to-be-detected light and generates a second sub-signal, the transmission rate signal comprises the first sub-signal and the second sub-signal, and the first optical transceiver and the second optical transceiver are disposed on two opposite sides of the document.

8. The document scanner according to claim 7, wherein the controller controls the penetrating light source according to an average level represented by the first sub-signal and the second sub-signal.

9. The document scanner according to claim 7, further comprising:
a second penetrating light source outputting second original penetrating light, which penetrates through the document and becomes second to-be-detected penetrating light; and
a second image sensor receiving the second to-be-detected penetrating light and generates a second image signal, wherein the controller is further electrically connected to the second penetrating light source and the second image sensor, wherein:
the controller controls, according to the second sub-signal, the penetrating light source to output the light-emitting amount of the original penetrating light; and
the controller controls, according to the first sub-signal, the second penetrating light source to output a light-emitting amount of the second original penetrating light.

10. The document scanner according to claim 1, wherein the document detector detects different transmission rates of multiple sections of the document and outputs the transmission rate signal, so that the original penetrating light outputs different light-emitting amounts to the document.
